(19) United States
(12) Patent Application Publication
(10) Pub. No.: US 2005/0205583 A1
(43) Pub. Date: Sep. 22, 2005

(54) Filling valve for a pressure vessel

(75) Inventor: Dieter Lutz, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/050,071

(22) Filed: Feb. 3, 2005

(30) Foreign Application Priority Data
Feb. 3, 2004 (DE) 10 2004 005 196.8

(51) Int. Cl. G21C 9/00

(52) U.S. Cl. 220/581

(57) ABSTRACT

Filling valve for a pressure vessel, which valve is located along with its fastening part along an edge of the pressure vessel, where the fastening part has a radially outward-curved surfaces and encloses a filling channel, and where the fastening part has a pressure-compensating space, the cross section of which is larger than the cross section of the filling channel.

### BACKGROUND OF THE INVENTION

1. Field of the Invention

The invention pertains to a filling valve for fastening to the edge of a pressure vessel, the filling valve having a fastening part having curved outer surfaces and enclosing a filling channel.

2. Description of the Related Art

U.S. Pat. No. 6,467,760 discloses a filling valve of the general type in question; it is welded into an open edge of the pressure vessel. As can be derived from FIG. 5, the filling valve has a curved surface, which is intended to form a continuous transition with the vessel inside the welded edge, so that no folds are formed inside the enclosing body underneath the filling valve. Such folds could lead to higher stresses and thus to the premature failure of the pressure vessel.

A pressure vessel of the same basic type with a cylindrical filling valve is described in U.S. Pat. No. 6,450,307. In this variant, the filling valve has a conical tip, which is welded into the edge, the purpose again being to minimize the formation of folds.

As a general rule, the formation of folds can be reduced by increasing the ratio of the length of the filling valve to its height, because then the folds can distribute themselves over a greater distance along the edge. But there is also the problem that the pressure vessel, when used in a vibration damper, is subjected to very high external pressures. It is disadvantageous in this regard that the filling valves are frequently made of plastic, which cannot withstand such pressures under certain conditions.

In U.S. Pat. No. 6,467,760, a filling valve is installed within a solid guide part of the vibration damper and is therefore well protected. In U.S. Pat. No. 6,450,307, an additional coating is used on the edges in the area of the filling valve. The use of an additional coating is not optimal for reasons of production technology, nor is it possible to provide a coating inside a guide part in all types of vibration dampers.

Another solution consists in providing the filling valve with external ribs, extending parallel to the edge. Such ribs, however, negatively affect the length-to-height ratio and thus promote the formation of folds.

### SUMMARY OF THE INVENTION

The task of the present invention is to realize a filling valve for a pressure vessel which can withstand high external pressures.

This task is accomplished according to the invention in that the fastening part has a pressure-compensating space with a cross section which is greater than that of the filling channel.

The great advantage is that the effective pressure inside the pressure vessel can be used as a counterforce to oppose the external pressure.

In another advantageous embodiment, the cross-sectional form of the pressure-compensating space is adapted to the cross-sectional form of the fastening part in such a way that the thickness of the walls forming the curved surfaces of the fastening part is as uniform as possible. A constant wall thickness for a filling valve made of plastic is desirable to avoid defects and warping. In addition, relatively thin walls can be used. This makes it easier to soften the edges when they are being welded to the filler piece, which thus increases the quality of the weld.

During welding, the edges of the pressure vessel are clamped onto the fastening part of the filling valve, but the pressure inside the pressure vessel is still the same as atmospheric pressure and is therefore of no use, i.e., not high enough to keep the fastening part from being squeezed shut during clamping. So that the mechanical load during welding can be absorbed more effectively, therefore, at least one reinforcing rib is provided inside the pressure-compensating space.

To create favorable boundary conditions for the welding operation, the minimum of one reinforcing rib inside the pressure-compensating space is shorter in the axial direction than the depth of the pressure-compensating space. A reinforcing rib of this type is also in principle a cooling rib, which dissipates the heat acting on the fastening part during welding. For this reason, the reinforcing rib should be as short as possible in the axial direction.

It is not important for the weld to be optimal over the entire axial length of the fastening part. The weld must simply be leak-tight toward the outside. For this reason, the minimum of one reinforcing rib proceeds from a bottom part of the pressure-compensating space. In the direction toward the pressure vessel, the fastening part can therefore be fabricated without a reinforcing rib over a certain part of its length, as a result of which the cooling rib effect cannot occur there, and consequently the optimal conditions for a high weld quality are obtained. At the same time, the wall of the fastening part is adequately supported during the welding process.

In an alternative variant, it is provided according to the invention that the fastening part, in the cross section parallel to the filling channel, is shorter in the direction toward the interior space of the pressure vessel than in the same plane at the outer edge. To avoid an oriented installation position, it is effective here to select a wedge-shaped cross section for the fastening part. This variant almost completely eliminates the formation of folds at the edges of the pressure vessel.

In addition, the fastening part can become shorter with increasing distance from the outer edge area of the pressure vessel, i.e., the fastening part slants inward from the outer edge of the filling channel. The basic idea is to minimize the volume of the fastening part which is present in the edge area of the pressure vessel.

In spite of its possibly wedge-shaped cross-sectional profile, the filling channel inside the fastening part is partially formed by the sleeve of the pressure vessel. Thus an extremely flat transition from the fastening part to the pressure vessel is created, because the height of the fastening component in the area of the filling channel can be reduced by an amount equal to nearly twice the conventional wall thickness of the fastening part.

In addition, the fastening part can have extension fins in the edge area. These extension fins are intended to increase the usable length of the fastening part and thus help to decrease the formation of folds in the pressure vessel.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows the pressure vessel in the installed state;

FIG. 2 shows the pressure vessel as a separate part;

FIGS. 3-5 show a first embodiment of a filling valve; and

FIGS. 6-9 show a second embodiment of a filling valve.

### DETAILED DESCRIPTION OF THE PRESENTLY PREFERRED EMBODIMENTS

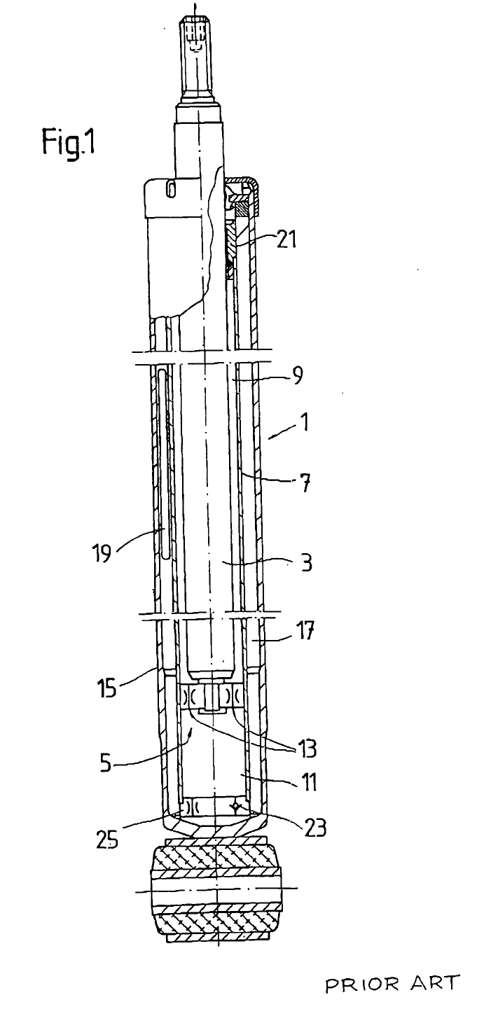

FIG. 1 shows a vibration damper 1 of the two-tube design known in and of itself, in which a piston rod 3 with a piston 5 is guided with freedom of axial movement inside a pressure tube 7. The piston 5 divides the pressure tube into an upper working space 9 and a lower working space 11, the two working spaces being connected to each other by damping valves 13 in the piston.

The pressure tube 7 is surrounded by a container tube 15. The inside wall of the container tube and the outside wall of the pressure tube form a compensating space 17, which is completely filled by damping medium and a gas-filled pressure vessel 19, which extends up as far as a piston rod guide 21. At the bottom end of the working space 11, a bottom piece is located, which can be provided with a check valve 23 and a damping valve 25.

When the piston rod moves, the volume displaced by the piston rod is compensated by a change in the volume of the pressure vessel 19.

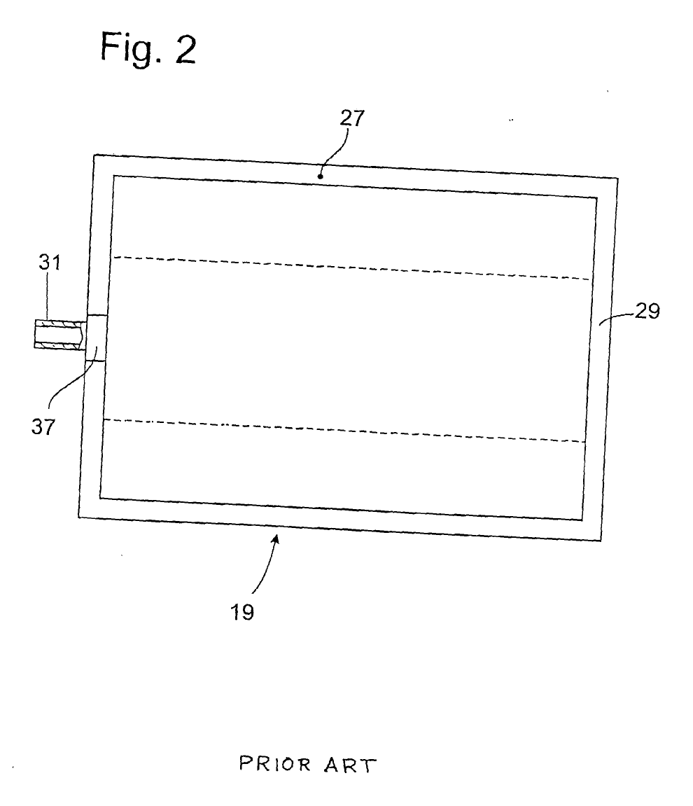

Referring to FIG. 2, the pressure vessel 19 consists of a sleeve body 27, the walls of which are welded together along their outer edges 29. A filling valve 31 is installed between the edges 29 to allow the pressure vessel 19 to be filled. This valve is laid in place when the edges are welded together.

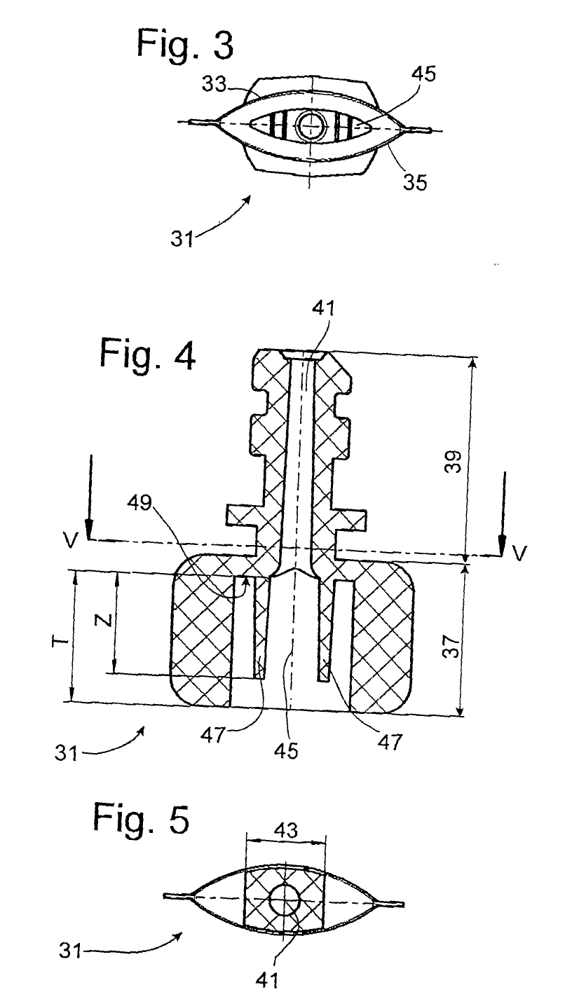

FIGS. 3-5 show the filling valve 31 according to a first embodiment. The filling valve 31 has a fastening part 37, which is welded to the edges 29 (FIG. 2). The fastening part 37 has radially outward-curved surfaces 33, 35 (FIGS. 3 and 5) on both sides, which are parallel to the edges. A filling part 39 with a continuous filling channel 41 is connected to the fastening part. The filling valve has key surfaces 43 to assist its alignment inside the edges of the pressure vessel.

It can be seen in FIG. 4 that, inside the fastening part 37, there is a pressure-compensating space 45, which opens out in the direction toward the interior of the pressure vessel. The cross section of this compensating space is significantly greater than that of the filling channel 41. The cross-sectional shape of the pressure-compensating space 46 matches the cross-sectional form of the fastening part 37 so that the thickness of the walls is as uniform as possible, as FIG. 3 shows.

Inside the pressure-compensating space 45, at least one reinforcing rib 47 proceeds in a direction parallel to the filling channel 41. The rib starts from the bottom 49 of the pressure-compensating space. The length Z of the minimum of one reinforcing rib 47 inside the pressure-compensating space 45 is shorter in the axial direction than the depth T of the pressure-compensating space 45.

When, as a result of the movement of the piston rod, an elevated pressure is produced inside the compensating space 17 of the vibration damper, the filling piece 31 is subjected to external load in the area of the fastening part 37 across the edge 29 of the pressure vessel 19. In the interior of the pressure vessel, an opposing pressure builds up, which also acts in the pressure-compensating space 45 from the inside toward the outside, so that the pressure load on the fastening part 37, of the filling valve 31 remains comparatively low.

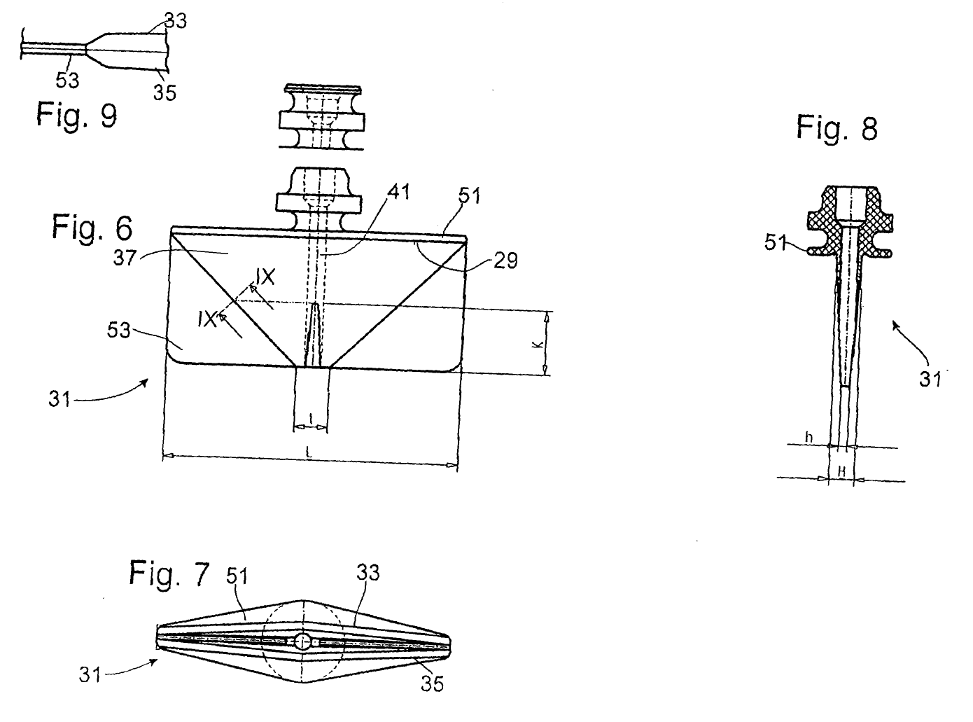

FIGS. 6-9 show an alternative embodiment of a filling valve 31. It can be derived from FIG. 7 that this variant, too, has a fastening part with radially outward-curved surfaces 33, 35 on both sides. In addition, in the cross section parallel to the filling channel 41, the height “h” of the fastening part is smaller in the interior of the pressure vessel than the height “H” in the same plane at the outer edge 29 of the sleeve body, as FIG. 8 is intended to illustrate. The fastening part 31 is thus wedge-shaped. It can also be seen in FIG. 6 that the length of the fastening part 37, which starts with a value of “L”, decreases progressively to a value of “I” with increasing distance from the outer edge 29 of the pressure vessel, which rests against the support webs 51, which are parallel to the edge 29 of the pressure vessel. As a result, a wedge-shaped profile is also obtained in a side view of the fastening part, to the edges of which extension fins 53 can be connected, the material of which, as shown in FIG. 9, is thinner than that of the fastening part 37. The wedge-shaped profile in cross section in conjunction with a filling channel 41 of uniform width is, as shown in FIG. 8, to dimensioned so that the filling channel 41 is bounded by the sleeve body 27 of the pressure vessel over a lengthwise section K. It can be seen in FIG. 6 that, in the lengthwise section K, only one section of the lateral wall of the fastening part 37 actually forms the boundary of the filling channel 41. As a result, a very flat transition is obtained between the fastening part and the interior of the pressure vessel.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A pressure vessel comprising a sleeve having an edge provided with a filling valve, the filling valve comprising:
a fastening part fastened to the edge of the pressure vessel, the fastening part walls having curved outer surfaces;
a filling channel passing through the fastening part; and
a pressure compensating space in the fastening part, the compensating space communicating with the filling channel and having a larger cross-section than the filling channel.

2. The pressure vessel of claim 1 wherein the compensating space has a shape which matches the curved surfaces, the walls having a uniform thickness.

3. The pressure vessel of claim 1 further comprising at least one reinforcing rib in the compensating space.

4. The pressure vessel of claim 3 wherein the pressure compensating space has a depth, the reinforcing rib has an axial dimension which is shorter than the depth.

5. The pressure vessel of claim 3 wherein the compensating space has a bottom, the reinforcing rib extending from the bottom.

6. The pressure vessel of claim 1 wherein the fastening part has a height at the edge of the pressure vessel which is greater than the height of the fastening part in the interior of the pressure vessel.

7. The pressure vessel of claim 6 wherein the fastening part has a length which becomes shorter with increasing distance from the edge of the pressure vessel.

8. The pressure vessel of claim 6 wherein the filling channel has a boundary inside the fastening part, said boundary being formed in part by the sleeve.

9. The pressure vessel of claim 6 wherein the fastening part has fins for welding against the edge of the pressure vessel.
